(19) United States
(12) Patent Application Publication
(10) Pub. No.: US 2009/0143009 A1
(43) Pub. Date: Jun. 4, 2009

(54) COMMUNICATION SYSTEM AND COMMUNICATION APPARATUS

(75) Inventor: Kazuji Sasaki, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/270,001

(22) Filed: Nov. 13, 2008

(30) Foreign Application Priority Data
Nov. 29, 2007 (JP) 2007-308301

(51) Int. Cl. H04B 5/00

(52) U.S. Cl. 455/41.1

(57) ABSTRACT

A communication system for carrying out noncontact transmissions of a close-coupled type by adoption of an electrostatic capacitive coupling method, the communication system includes: a signal transmitting apparatus having a signal transmitting electrode and a section configured to apply a baseband signal representing transmitted data to the signal transmitting electrode as a transmitted signal; and a signal receiving apparatus having a signal receiving electrode and a signal demodulation section configured to carry out a binary conversion demodulation process on a received signal appearing at the signal receiving electrode to reproduce the baseband signal, wherein, when the signal transmitting electrode and the signal receiving electrode closely couple to each other, an electrostatic capacitive coupler equivalent to a capacitor coupling circuit is formed and the transmitted signal is propagated through a small capacitance created between the signal transmitting electrode and the signal receiving electrode.

### CROSS REFERENCES TO RELATED APPLICATIONS

The present application claims priority to Japanese Patent Application JP 2007-308301 filed in the Japan Patent Office on Nov. 29, 2007, the entire contents of which is being incorporated herein by reference.

### BACKGROUND

In general, the present application relates to a communication system for carrying out radio communications of short distances by making use of noncontact means and communication apparatus employed in the communication system. In particular, the present application relates to a communication system making use of noncontact means for transmitting data from a communication terminal serving as a transponder not provided with a source for generating electric waves by itself to a reader/writer apparatus serving as a communication partner of the transponder, and relates to communication apparatus employed in the communication system.

A noncontact communication system called RFID (Radio Frequency IDentification) is known as a typical communication system for transmitting data by making use of a radio communication from a communication terminal not provided with a source for generating electric waves by itself to an apparatus serving as a communication partner of the communication terminal. The RFID is also referred to as an ID system or a data carrier system. However, an RFID system shortened hereafter to merely the RFID is a technical term commonly used worldwide. The Japanese translation of the RFID is a recognition system making use of high-frequency radio waves.

The RFID is applied to a large number of noncontact IC cards. As a typical RFID system, an IC-card system includes an IC (Integrated Circuit) card and a reader/writer apparatus shortened hereafter to merely a reader/writer. The IC card is used as a transponder whereas the reader/writer is an apparatus for reading out information from the IC card and writing information into the IC card. Since the IC-card system allows information to be exchanged between the IC card and the reader/writer through a noncontact communication, the IC-card system offers much convenience and, in recent years, the application range of the IC card for carrying out noncontact transmissions of signals has been becoming wide to include applications such as tickets, commuter passes and payments made at convenience stores.

Depending on the distance of the transmission, the noncontact transmissions of signals can be classified into 3 categories, i. e., close-coupled-contact noncontact transmissions of signals for the transmission range 0 to 2 mm, adjacent noncontact transmissions of signals for the transmission range 0 to 10 cm and vicinity noncontact transmissions of signals for the transmission range 0 to 70 cm. These 3 categories are prescribed by international standards, i. e., the ISO/IEC10536, the ISO/IEC14443 and the ISO/IEC15693 respectively. For example, the noncontact IC cards each used as an electronic ticket for the Japan Railways pertain to the category of adjacent noncontact transmissions of signals. Each of these electronic tickets is capable of exchanging information with a reader/writer at relatively low transmission speed of 212 kbps. The IC card prescribed in the international standard called the ISO/IEC10536 to serve as an IC card for noncontact transmissions of signals at close-coupled contact makes use of a transmission carrier requiring modulation and demodulation circuits so that the structure of a communication system based on the IC card is complicated. This IC card also has other shortcomings such as a relatively low transmission speed of 9,600 bps.

In addition, the noncontact transmission of signals at close-coupled contact adopts either an inductive coupling method or an electrostatic capacitive coupling method. For example, in the case of the electrostatic capacitive coupling method adopted as a technique for communicating a signal by making use of an electrostatic capacitor having a small inter-electrode gap as an electrostatic capacitive coupler, there has been proposed a communication system for implementing a high-speed communication by carrying out a Manchester coding process on a baseband signal in order to transform the signal into a wide frequency spectrum. For details of the proposed communication system, the reader is suggested to refer to documents such as Japanese Patent Laid-open No. 2005-79783.

In the Manchester code system, at the center of a bit interval, a high level is changed to a low level when transmitting a binary value of “0.” When transmitting a binary value of “1,” on the other hand, a low level is changed to a high level at the center of a bit interval. In other words, the Manchester code system eliminates the DC component of a transmitted signal by widening the band to a band having a width equal to twice the original width. Thus, in the communication system described above, a Manchester coding process is carried out to double the speed of a transmitted or received signal. In consequence, the communication system has shortcomings that a high-cost circuit capable of operating at a high speed is required and that, at a low data transmission speed, the level of a received waveform is small, making the operation instable.

### SUMMARY

In an embodiment, a noncontact communication system is provided that is capable of transmitting data from a communication terminal serving as a transponder not provided with a source for generating electric waves by itself to a reader/writer apparatus serving as a communication partner of the transponder by making use of radio communication, and innovated communication apparatus to be employed in the communication system.

In another embodiment, a noncontact communication system is provided that is capable of carrying out noncontact radio communications by adoption of an electrostatic capacitive coupling method for communicating a signal by making use of an electrostatic capacitor having a small inter-electrode gap as an electrostatic capacitive coupler, and innovated communication apparatus to be employed in the communication system.

In a further embodiment, a noncontact communication system is provided that can be designed with ease at a low cost to serve as a communication system capable of carrying out noncontact radio communications based on an electrostatic capacitive coupling method in a wide allowable continuous range from data to be transmitted at a low speed to data to be transmitted at a high speed, and innovated communication apparatus to be employed in the communication system.

In an embodiment, a communication system is provided for carrying out noncontact transmissions of a close-coupled type by adoption of an electrostatic capacitive coupling method. The communication system in an embodiment includes: a signal transmitting apparatus having a signal transmitting electrode and a section configured to apply a baseband signal representing transmitted data to the signal transmitting electrode as a transmitted signal; and a signal receiving apparatus having a signal receiving electrode and a signal demodulation section configured to carry out a binary conversion demodulation process on a received signal appearing at the signal receiving electrode to reproduce the baseband signal.

The communication system is characterized in that, when the signal transmitting electrode and the signal receiving electrode closely couple to each other, an electrostatic capacitive coupler equivalent to a capacitor coupling circuit is formed and the transmitted signal is propagated through a small capacitance created between the signal transmitting electrode and the signal receiving electrode.

It is also to be noted, however, that the technical term ‘system’ used in this specification is defined as the configuration of a confluence including a plurality of apparatus or a plurality of functional modules and the definition does not particularly raise a question as to whether the apparatus or the functional modules are provided in a single case.

In recent years, the range of applications each making use of an IC card designed for noncontact transmissions of signals has been widening. As explained before, the ICO/IEC10536 is a typical international standard prescribing a noncontact IC card of a close-coupled type for short transmission distances. However, such an IC card makes use of a transmission carrier requiring modulation and demodulation circuits so that the structure of a communication system based on the IC card is complicated. This IC card also has other shortcomings such as a relatively low transmission speed of 9,600 bps.

In addition, as described earlier, the noncontact transmission of signals through close-coupled contact adopts either an inductive coupling method or an electrostatic capacitive coupling method. For example, in the case of the electrostatic capacitive coupling method adopted as a technique for communicating a signal by making use of an electrostatic capacitor having a small inter-electrode gap as an electrostatic capacitive coupler, there has been proposed a communication system for implementing a high-speed communication by carrying out a Manchester coding process on a baseband signal in order to transform the signal into a wide frequency spectrum. However, the Manchester coding process is carried out to double the speed of a transmitted or received signal. In consequence, the communication system has shortcomings that a high-cost circuit capable of operating at a high speed is required and that, at a low data transmission speed, the level of a received waveform is small, making the operation instable.

In accordance with an embodiment, on the other hand, in a noncontact communication system of the close-coupled type, an electrostatic capacitor composed of parallel planar electrodes provided on the signal transmitting side and the signal receiving side respectively to function as electrodes facing each other is used as an electrostatic capacitive coupler. A signal transmitting apparatus on the signal transmitting side supplies a baseband signal to the electrode provided on the signal transmitting side as a transmitted signal whereas a signal receiving apparatus on the signal receiving side carries out a binary conversion demodulation process on the waveform of a transmitted signal appearing at the electrode provided on the signal receiving side to reproduce the baseband signal by making use of a comparator having a hysteresis characteristic.

In the communication system according to the present embodiment, typically, the signal transmitting apparatus provided on the signal transmitting side corresponds to a transponder such as an IC card whereas the signal receiving apparatus provided on the signal receiving side corresponds to a reader/writer and data is exchanged between the signal transmitting apparatus and the signal receiving apparatus in noncontact transmissions through close-coupled contact by adoption of the electrostatic capacitive coupling method. An electrostatic capacitive coupler composed of a pair of aforementioned electrodes provided on the signal transmitting side and the signal receiving side respectively is equivalent to a capacitor coupling circuit and a transmitted signal can thus be propagated through an infinitesimal capacitance created between the electrodes.

In such a configuration, the electrostatic capacitive coupler having the infinitesimal capacitance exhibits a frequency characteristic equivalent to that of a high-pass filter. A baseband signal passing through the electrostatic capacitive coupler with the infinitesimal capacitance as a transmitted signal is converted into a signal having a differential waveform and appears in the signal receiving apparatus on the signal receiving side as a received signal. The baseband signal to propagate through the electrostatic capacitive coupler as a transmitted signal is a signal having a binary rectangular waveform.

The signal receiving apparatus on the signal receiving side carries out a binary conversion demodulation process on the waveform of a received signal generated by the electrostatic capacitive coupler with the infinitesimal capacitance at the electrode, which is provided on the signal receiving side to serve as an electrode for receiving data, to reproduce the baseband signal by making use of a comparator having a hysteresis characteristic.

The received signal generated by the electrostatic capacitive coupler with the infinitesimal capacitance at the electrode provided on the signal receiving side is converted into a differential signal at a changing point of the signal transmitted by the signal transmitting apparatus on the signal transmitting side. In the signal receiving apparatus, a signal demodulation section configured to operate as the comparator having a hysteresis characteristic examines only edges on each of which the level of the voltage of the received signal changes relatively to a comparison signal instead of examining the level of the voltage of the received signal throughout a symbol time T to be described later by referring to a waveform diagram of FIG. 7. Thus, the modulation/demodulation performance of the signal demodulation section is not dependent on the transmission rate but dependent only on the response characteristic of the signal demodulation section which is configured to operate as the comparator. As a result, by making use of a comparator operating at a high speed, it is possible to implement a communication system for carrying out noncontact radio communications based on an electrostatic capacitive coupling method in a wide allowable continuous range from data to be transmitted at a low speed to data to be transmitted at a high speed.

In accordance with an embodiment, it is possible to provide an excellent noncontact communication system capable of well transmitting data from a communication terminal serving as a transponder not provided with a source for generating electric waves by itself to a reader/writer apparatus serving as a communication partner of the transponder by making use of radio communication, and provide communication apparatus to be employed in the communication system.

In addition, in accordance with an embodiment, it is also possible to provide an excellent noncontact communication system capable of carrying out noncontact radio communications by adoption of an electrostatic capacitive coupling method for communicating a signal by making use of an electrostatic capacitor having a small inter-electrode gap as an electrostatic capacitive coupler, and provide communication apparatus to be employed in the communication system.

In accordance with an embodiment, it is also possible to provide an excellent noncontact communication system that can be designed with ease at a low cost to serve as a communication system capable of carrying out noncontact radio communications based on an electrostatic capacitive coupling method in a wide allowable continuous range from data to be transmitted at a low speed to data to be transmitted at a high speed, and provide communication apparatus to be employed in the communication system.

As described above, the communication system according to an embodiment is capable of carrying out noncontact radio communications by adoption of an electrostatic capacitive coupling method. However, the communication system is configured to have the signal transmitting apparatus transmit a baseband signal directly to the signal receiving apparatus as it is without carrying out the Manchester coding process or the like. Thus, the communication system does not require a transmission-carrier generation circuit, a data modulation circuit and a signal demodulation circuit. In addition, the communication system does not require a digital-signal processing circuit in both the signal transmitting apparatus and the signal receiving apparatus. Thus, the communication system can be configured at a low cost and with ease.

In addition, by applying an embodiment to a communication system for carrying out signal noncontact transmissions of the close-coupled type, the communication system can be made capable of operating in a wide allowable continuous range from data to be transmitted at a low speed to data to be transmitted at a high speed. In this case, the communication system is capable of transmitting data without regard to whether the transmitted data is contiguous data or burst data.

In an embodiment, the present application generally relates to a communication system for carrying out noncontact radio communications by adoption of an electrostatic capacitive coupling method for communicating a signal by making use of an electrostatic capacitor having a small inter-electrode gap as an electrostatic capacitive coupler, and relates to communication apparatus employed in the communication system. More particularly, the present application in an embodiment relates to a communication system that can be designed with ease at a low cost to serve as a communication system for carrying out noncontact radio communications based on an electrostatic capacitive coupling method in a wide allowable continuous range from data to be transmitted at a low speed to data to be transmitted at a high speed, and relates to communication apparatus employed in the communication system.

Additional features and advantages are described herein, and will be apparent from the following Detailed Description and the figures.

### BRIEF DESCRIPTION OF THE FIGURES

FIG. 1 is a model diagram showing some typical applications of the present embodiment;

FIG. 2 is a block diagram showing a model representing a flow of still-picture data stored in advance in a memory employed in a digital still camera from the memory to a PC (Personal Computer);

FIG. 3 is a diagram showing the configuration of an electrostatic capacitive coupler including a still-camera electrode employed in a digital still camera provided on the signal transmitting side and a reader/writer electrode which is employed in a reader/writer provided on the signal receiving side as an electrode facing the still-camera electrode;

FIG. 4 is a diagram showing a typical configuration including components ranging from a signal transmitting amplifier employed in the digital still camera provided on the signal transmitting side to a binary conversion circuit employed in the reader/writer provided on the signal receiving side;

FIG. 5 is a circuit diagram showing a typical configuration of the binary conversion circuit employed in the reader/writer;

FIG. 6 is a diagram showing the waveforms of a transmitted signal generated by the digital still camera and a received signal generated in the reader/writer in the configuration shown in the diagram of FIG. 4 as well as a signal output by the binary conversion circuit included in the same configuration;

FIG. 7 is a diagram showing typical waveforms of a transmitted signal generated by the digital still camera as a baseband signal, a received signal appearing at the reader/writer electrode employed in the reader/writer as an electrode of the electrostatic capacitive coupler passing on the transmitted signal and a binary output signal output by the binary conversion circuit of the reader/writer as a signal resulting from a binary conversion demodulation process carried out by the binary conversion circuit;

FIG. 8 is a diagram showing another typical configuration including components ranging from the signal transmitting amplifier employed in the digital still camera provided on the signal transmitting side to the binary conversion circuit employed in the reader/writer provided on the signal receiving side; and

FIG. 9 is a diagram showing a further typical configuration including components ranging from the signal transmitting amplifier employed in the digital still camera provided on the signal transmitting side to the binary conversion circuit employed in the reader/writer provided on the signal receiving side.

### DETAILED DESCRIPTION

An embodiment of the present application is explained in detail below with reference to the figures.

The present embodiment provides a noncontact communication system capable of transmitting data from a communication terminal serving as a transponder not provided with a source for generating electric waves by itself to a reader/writer apparatus serving as a communication partner of the transponder by making use of radio communication. In particular, the present embodiment provides an excellent noncontact communication system for carrying out signal noncontact transmissions of the close-coupled type.

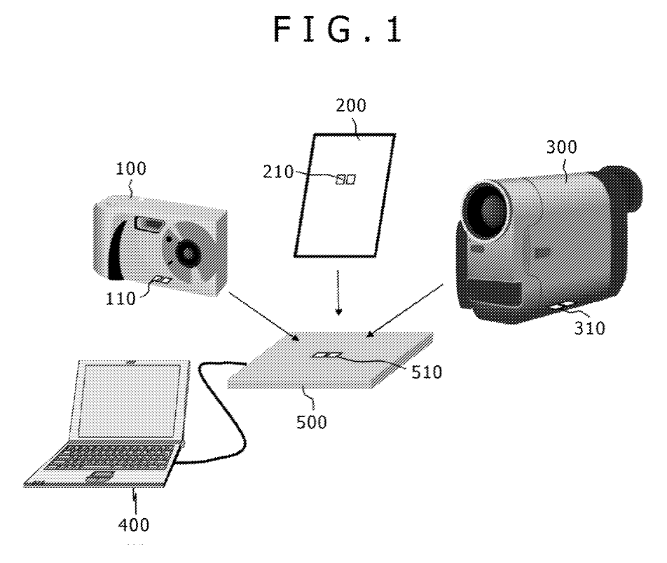

FIG. 1 is a model diagram showing some typical applications of the present embodiment. In the typical applications shown in the diagram of FIG. 1, a reader/writer 500 is configured to serve as an external input/output apparatus connected to a PC (Personal Computer) 400. For example, the reader/writer 500 is connected to the PC 400 through an interface such as a USB or an I²C. The reader/writer 500 includes a reader/writer electrode 510 embedded on the inner side of the upper surface of the reader/writer 500 to serve as an electrode composing an electrostatic capacitive coupler in conjunction with an electrode employed in a transponder such as a digital still camera 100, a noncontact IC card 200 or a digital video camera 300.

A typical example of the transponder is the noncontact IC card 200 including a IC-card electrode 210 embedded therein to serve as an electrode composing an electrostatic capacitive coupler in conjunction with the reader/writer electrode 510. Other typical examples of the transponder are the digital still camera 100 and the digital video camera 300, each of which has the function of an IC card. For example, the digital still camera 100 or 300 employs a still-camera electrode 110 or 310 embedded on the inner side of the bottom of the body of the digital still camera 100 or 300 to serve as an electrode composing an electrostatic capacitive coupler in conjunction with the reader/writer electrode 510. In any one of the typical examples of the transponder, when the still-camera electrode 110, the IC-card electrode 210 or the video-camera electrode 310 is brought to a location closely coupling to the reader/writer electrode 510 employed in the reader/writer 500 so as to face the reader/writer electrode 510, an inter-electrode electrostatic capacitive coupling effect works, allowing data to be exchanged between the transponder and the reader/writer 500 through a noncontact communication. The still-camera electrode 110, the IC-card electrode 210 or the video-camera electrode 310 is brought to a location closely coupling to the reader/writer electrode 510 by typically mounting the digital still camera 100, the noncontact IC card 200 or the digital video camera 300 respectively on the reader/writer 500. With the still-camera electrode 110, the IC-card electrode 210 or the video-camera electrode 310 brought to a location closely coupling to the reader/writer electrode 510, a still picture taken by making use of the digital still camera 100, data stored in the noncontact IC card 200 or a moving picture taken by making use of the digital video camera 300 is transferred at a high speed to the PC 400 by way of the reader/writer 500 and, conversely, data stored in the PC 400 is written into an external storage medium employed in the digital still camera 100, the noncontact IC card 200 or the digital video camera 300 respectively by way of the reader/writer 500.

The following description explains an embodiment transferring data of a still picture from the digital still camera 100 having the embedded function of a transponder to the PC 400 by way of the reader/writer 500.

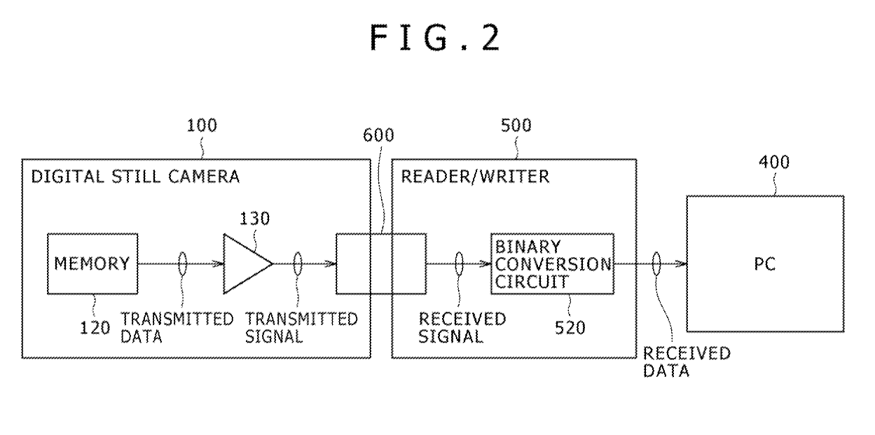

FIG. 2 is a block diagram showing a model representing a flow of still-picture data stored in advance in a memory 120 employed in the digital still camera 100 from the memory 120 to the PC 400.

The still-picture data stored in advance in the memory 120 employed in the digital still camera 100 is data to be transmitted to the PC 400. The still-picture data stored in advance in the memory 120 is read out from the memory 120 and amplified by a signal transmitting amplifier 130 employed in the digital still camera 100. A signal output by the signal transmitting amplifier 130 is supplied to an electrostatic capacitive coupler 600 as a transmitted signal.

The electrostatic capacitive coupler 600 is composed of the still-camera electrode 110 employed in the digital still camera 100 and the reader/writer electrode 510 employed in the reader/writer 500. The electrostatic capacitive coupler 600 is equivalent to a capacitor coupling circuit allowing a signal to propagate through an infinitesimal coupling capacitance generated between the still-camera electrode 110 and the reader/writer electrode 510 which form a capacitor of the electrostatic capacitive coupler 600. Since the coupling capacitance of the electrostatic capacitive coupler 600 is very small, however, the waveform of a transmitted baseband signal propagating through the coupling capacitance is reshaped into a differential waveform like one output by an HPF (High Pass Filter). The transmitted baseband signal appears on the reader/writer electrode 510 of the reader/writer 500 as a received signal having the differential waveform. A binary conversion circuit 520 provided at a stage following the reader/writer electrode 510 employed in the reader/writer 500 carries out a binary conversion demodulation process on the received signal in order to reproduce a baseband signal having an NRZ (Non Return to Zero) format. Finally, the reader/writer 500 supplies the reproduced baseband signal obtained as a result of the binary conversion demodulation process to the PC 400.

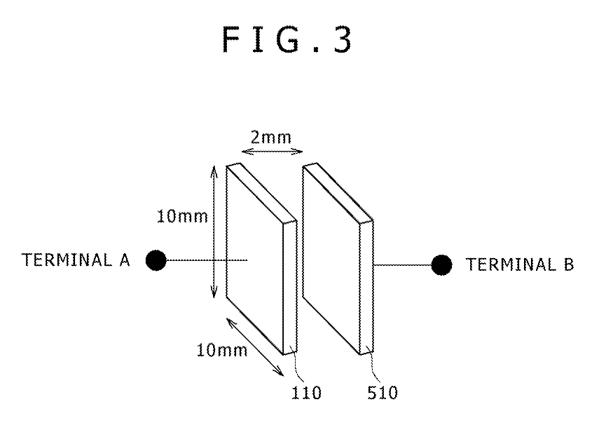

FIG. 3 is a diagram showing the configuration of the electrostatic capacitive coupler 600. The capacitance of the electrostatic capacitive coupler 600 composed of the still-camera electrode 110 and the reader/writer electrode 510 which are positioned as electrodes facing each other can be found from the sizes of the still-camera electrode 110 and the reader/writer electrode 510, the distance between the still-camera electrode 110 and the reader/writer electrode 510 as well as the dielectric constant of a substance existing between the still-camera electrode 110 and the reader/writer electrode 510. In the typical electrostatic capacitive coupler 600 shown in the diagram of FIG. 3, each of the still-camera electrode 110 and the reader/writer electrode 510 has a square shape with a side length of 10 mm whereas the distance between the still-camera electrode 110 and the reader/writer electrode 510 is 2 mm. In this case, the capacitance of the electrostatic capacitive coupler 600 is found as a capacitance between terminals A and B shown in the diagram of FIG. 3. Thus, the capacitance of the electrostatic capacitive coupler 600 can be simply found in accordance with a capacitance computation equation (1) given as follows.

$$C = {e}_{0} \cdot {e}_{s} \cdot \frac{S}{D} \qquad ( 1 )$$

In the above equation, notation C denotes the capacitance expressed in terms of farads [F] as the capacitance of the electrostatic capacitive coupler 600, notation eₒ denotes a dielectric constant expressed in terms of [F/m] as the dielectric constant of the vacuum, notation eₛ denotes a specific permittivity which has a value of 1 in the case of the air, notation S denotes an area expressed in terms of square meters [m²] as the area of each of the still-camera electrode 110 and the reader/writer electrode 510 whereas notation D denotes a distance expressed in terms of meters [m] as the distance between the still-camera electrode 110 and the reader/writer electrode 510. By substituting typical values of S=10×10 [mm²], D=2 [mm], eₒ=8.85419 e⁻¹² [F/m] and eₛ≈1 into Eq. (1) as substitutes for the area S, the distance D, the dielectric constant of the vacuum and the specific permittivity respectively, the capacitance of the electrostatic capacitive coupler 600 can be found to be 0.44 [pF] as shown in Eq. (2) given below. The value of the specific permittivity eₛ is set at a value equal to about 1 on the assumption that air exists between the still-camera electrode 110 and the reader/writer electrode 510.

$$C = 8.85419 e - 12 \cdot 1 \cdot \frac{1 e - 4}{0.002} \approx 0.44 [ F ] \qquad ( 2 )$$

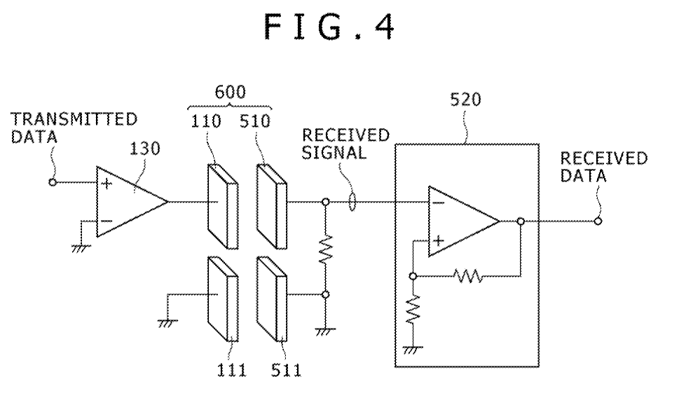

FIG. 4 is a diagram showing a typical configuration including components ranging from the signal transmitting amplifier 130 employed in the digital still camera 100 provided on the signal transmitting side to a binary conversion circuit 520 employed in the reader/writer 500 provided on the signal receiving side. In the typical configuration, the electrostatic capacitive coupler 600 includes the still-camera electrode 110 and the reader/writer electrode 510 which are aligned along the signal line to form a pair and also includes another still-camera electrode 111 and another reader/writer electrode 511 which are aligned along the ground line to form a pair. The electrostatic capacitive coupling is formed by the still-camera electrode 110 in conjunction with the reader/writer electrode 510 and the still-camera electrode 111 in conjunction with the reader/writer electrode 511. In the typical example shown in the diagram of FIG. 4, each of the digital still camera 100 and the reader/writer 500 is configured in an input/output form of an unbalanced type. However, each of the digital still camera 100 and the reader/writer 500 can also be configured in an input/output form of a balanced type to give essentially the same configuration as the unbalanced type.

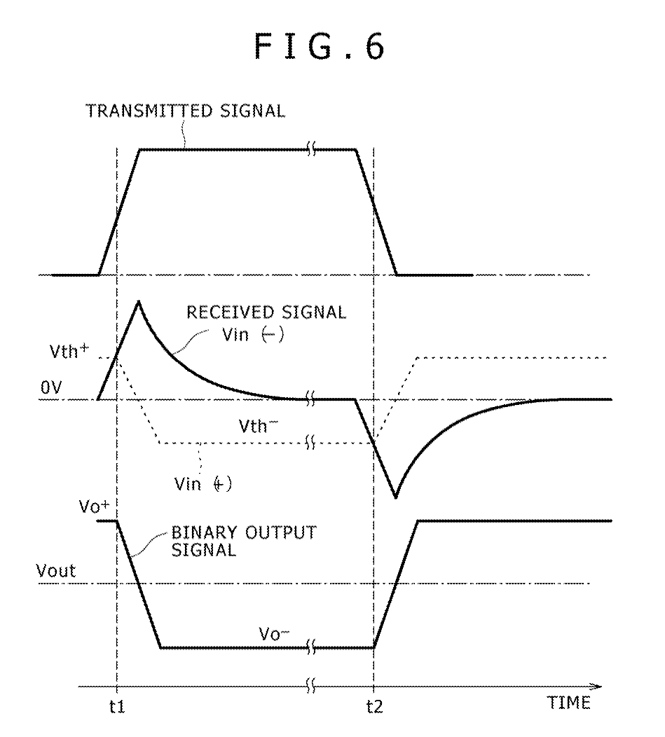

FIG. 6 is a diagram showing the waveforms of a transmitted signal generated by the digital still camera 100 and a received signal generated in the reader/writer 500 in the configuration shown in the diagram of FIG. 4 as well as a signal output by a binary conversion circuit 520 included in the same configuration. The horizontal axis of the diagram of FIG. 6 represents the lapse of time. As shown in the waveform diagram of FIG. 6, the received signal generated between the 2 electrodes 510 and 511 has a waveform obtained by differentiating the waveform of the transmitted signal. Thus, with the waveform of the received signal kept in this state as it is, the received signal cannot be used as received data. For this reason, the received signal is supplied to the binary conversion circuit 520 for carrying out a binary conversion demodulation process to produce a binary output signal, which is the inverted signal of the transmitted signal or the original baseband signal.

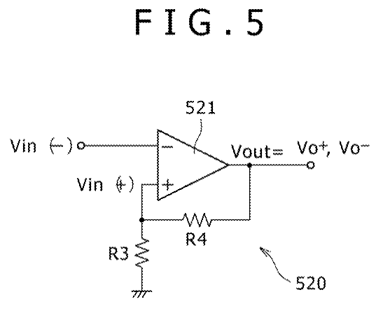

FIG. 5 is a circuit diagram showing a typical configuration of the binary conversion circuit 520 employed in the reader/writer 500. The binary conversion circuit 520 shown in the circuit diagram of FIG. 5 employs a comparator 521 as well as resistors R3 and R4. The binary conversion circuit 520 is a voltage comparison circuit having a hysteresis characteristic.

An output voltage Vₒᵤₜ generated by the comparator 521 is divided by making use of a voltage divider consisting of the resistors R3 and R4, and a partial voltage obtained as a result of the voltage division is supplied back to a non-inverting input terminal Vᵢₙ (+) of the comparator 521. The received signal shown in the diagram of FIG. 4 is supplied to an inverting input terminal Vᵢₙ (−) of the comparator 521 in order to compare the level of the received signal with the level of the voltage appearing at the non-inverting input terminal Vᵢₙ (+). If the level of the received signal supplied to the inverting input terminal Vᵢₙ (−) is found higher than the level of the voltage appearing at the non-inverting input terminal Vᵢₙ (+), a Vₒ− voltage is output from an output terminal Vₒᵤₜ of the comparator 521. If the level of the received signal supplied to the inverting input terminal Vᵢₙ (−) is found lower than the level of the voltage appearing at the non-inverting input terminal Vᵢₙ (+), on the other hand, a Vₒ+ voltage is output from an output terminal Vₒᵤₜ of the comparator 521.

By the way, the voltage appearing at the non-inverting input terminal Vᵢₙ (+) as a voltage to be compared with the received signal supplied to the inverting input terminal Vᵢₙ (−) is the partial voltage obtained as a result of dividing the output voltage Vₒᵤₜ generated by the comparator 521 and thus dependent on the output voltage Vₒᵤₜ. That is to say, when the output voltage Vₒᵤₜ generated by the comparator 521 is the Vₒ+ voltage, the voltage appearing at the non-inverting input terminal Vᵢₙ (+) is equal to Vₜₕ+ which is expressed by Eq. (3) given below. When the output voltage Vₒᵤₜ generated by the comparator 521 is the Vₒ− voltage, on the other hand, the voltage appearing at the non-inverting input terminal Vᵢₙ (+) is equal to Vₜₕ− which is expressed by Eq. (4) given below. Thus, the comparator 521 has a hysteresis characteristic.

$$\begin{matrix}Vth += \frac{R 3}{R 3 + R 4} \cdot Vo + & ( 3 ) \\ Vth -= \frac{R 3}{R 3 + R 4} \cdot Vo - & ( 4 )\end{matrix}$$

In the waveform diagram of FIG. 6, a middle waveform shown in the waveform diagram of FIG. 6 as a waveform represented by a solid line is the waveform of the received signal supplied to the inverting input terminal Vᵢₙ (−) as a signal generated by the so-called inter-electrode electrostatic capacitive coupling effect whereas a middle waveform represented by a dashed line is the waveform of the voltage supplied to non-the inverting input terminal Vᵢₙ (+). As is obvious from the middle waveforms, in a period before a time t1, the level of the received signal supplied to the inverting input terminal Vᵢₙ (−) is lower than the level of the voltage Vₜₕ+ appearing at the non-inverting input terminal Vᵢₙ (+). During a period from the time t1 to a time t2, however, the level of the received signal supplied to the inverting input terminal Vᵢₙ (−) is higher than the level of the voltage Vₜₕ− appearing at the non-inverting input terminal Vᵢₙ (+). In a period after the time t2, the level of the received signal supplied to the inverting input terminal Vᵢₙ (−) is again lower than the level of the voltage Vₜₕ+ appearing at the non-inverting input terminal Vᵢₙ (+). As is obvious from top and bottom waveforms, the output voltage Vₒᵤₜ represents a signal obtained by inverting the transmitted signal. However, a signal inverting amplifier for inverting the logic level of the output voltage Vₒᵤₜ is provided at a later stage. Shown in none of the figures, the signal inverting amplifier generates received data to be supplied to the PC 400.

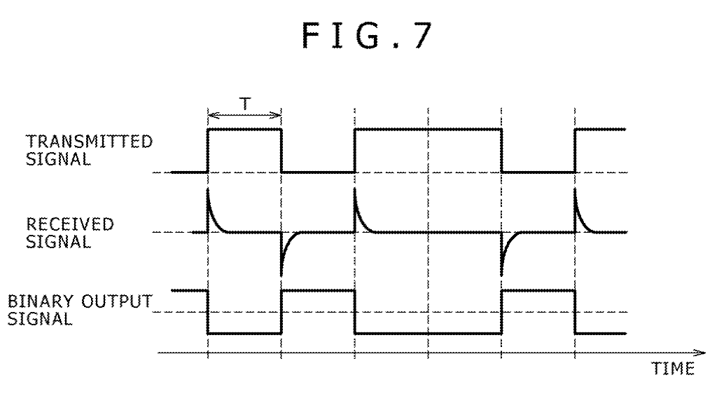

Much like the waveform diagram of FIG. 6, FIG. 7 is a diagram showing typical waveforms of the transmitted signal at the top, the received signal in the middle and the binary output signal at the bottom. The transmitted signal is a baseband signal generated by the digital still camera 100. This baseband signal is transmitted to the reader/writer 500 by way of the electrostatic capacitive coupler 600 and appears at the reader/writer electrode 510 of the reader/writer 500 as the received signal. The binary output signal is the output voltage Vₒᵤₜ generated by the binary conversion circuit 520 as a result of a binary conversion demodulation process. In the waveform diagram of FIG. 7, notation T denotes 1 symbol time. As is obvious from the top and middle waveforms, the received signal is a differential signal obtained as a result of the so-called inter-electrode electrostatic capacitive coupling effect demonstrated by the electrostatic capacitive coupler 600 as an effect of differentiating the transmitted signal. Thus, basically, the symbol time T is not affected. That is to say, the baseband signal can be transmitted from the digital still camera 100 to the reader/writer 500 without regard to the data speed.

The comparator 521 functioning as a signal demodulation section having the hysteresis characteristic examines only edges at times t1 and t2 at each of which the level of the voltage of the received signal changes relatively to the comparison signal supplied to the non-inverting input terminal Vᵢₙ (+) of the comparator 521 instead of examining the level of the voltage of the received signal throughout a symbol time T. Thus, the modulation/demodulation performance of the comparator 521 is not dependent on the transmission rate but dependent on the response characteristic of the comparator 521. As a result, it is possible to implement a communication system for carrying out noncontact radio communications based on an electrostatic capacitive coupling method in a wide allowable continuous range from data to be transmitted at a low speed to data to be transmitted at a high speed.

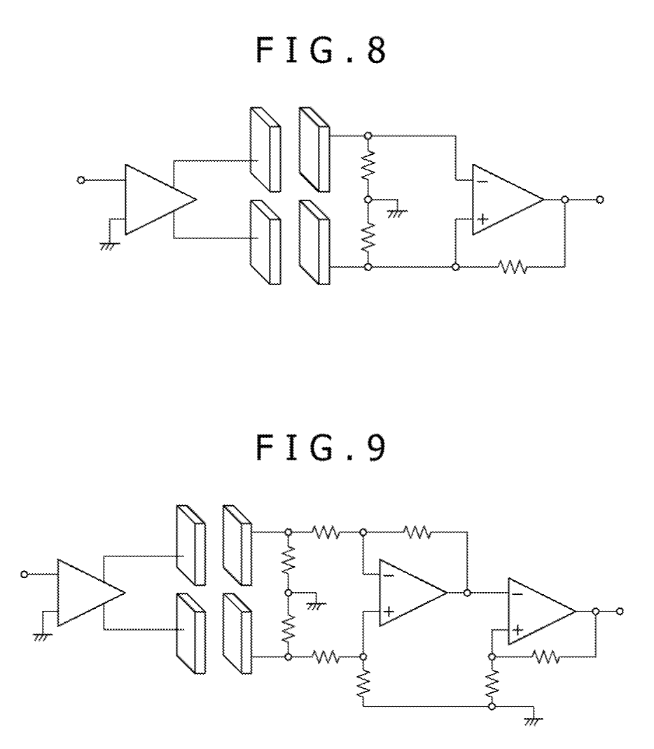

FIG. 8 is a diagram showing another typical configuration including components ranging from the signal transmitting amplifier 130 employed in the digital still camera 100 provided on the signal transmitting side to the binary conversion circuit 520 employed in the reader/writer 500 provided on the signal receiving side. In the typical circuit shown in the diagram of FIG. 8, the signal transmitting amplifier 130 is an amplifier of the balance type whereas a comparator included in the binary conversion circuit 520 is also a comparator having the hysteresis characteristic.

FIG. 9 is a diagram showing another typical configuration including components ranging from the signal transmitting amplifier 130 employed in the digital still camera 100 provided on the signal transmitting side to the binary conversion circuit 520 employed in the reader/writer 500 provided on the signal receiving side. The reader/writer 500 also employs a signal receiving amplifier. In the typical circuit shown in the diagram of FIG. 9, each of the signal transmitting amplifier 130 and the signal receiving amplifier is an amplifier of the balance type whereas a comparator included in the binary conversion circuit 520 is also a comparator having the hysteresis characteristic.

Each of the typical circuits shown in the diagrams of FIGS. 8 and 9 is an application circuit which carries out the same operations as that carried out by the typical circuit shown in the diagram of FIG. 4. Thus, the reader should understand with ease that each of the typical circuits shown in the diagrams of FIGS. 8 and 9 also falls within the scope of the present embodiment.

In signal noncontact transmissions of the close-coupled-contact type, the communication system provided by the present embodiment is capable of carrying out noncontact radio communications based on an electrostatic capacitive coupling method in a wide allowable continuous range from data to be transmitted at a low speed to data to be transmitted at a high speed. In addition, the received signal is a differential signal obtained as a result of the so-called inter-electrode electrostatic capacitive coupling effect of differentiating the transmitted signal so that the received signal has large values at the rising and falling edge of the transmitted signal. Nevertheless, the communication system is capable of transmitting data without regard to whether the transmitted data is contiguous data or burst data.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A communication system for carrying out noncontact transmissions of a close-coupled type by adoption of an electrostatic capacitive coupling method, said communication system comprising:
a signal transmitting apparatus having
a signal transmitting electrode and
means configured to apply a baseband signal representing transmitted data to said signal transmitting electrode as a transmitted signal; and
a signal receiving apparatus having
a signal receiving electrode and
signal demodulation means configured to carry out a binary conversion demodulation process on a received signal appearing at said signal receiving electrode to reproduce said baseband signal,
wherein, when said signal transmitting electrode and said signal receiving electrode closely couple to each other, an electrostatic capacitive coupler equivalent to a capacitor coupling circuit is formed and said transmitted signal is propagated through a small capacitance created between said signal transmitting electrode and said signal receiving electrode.

2. The communication system according to claim 1, wherein said signal demodulation means has a comparator provided with a hysteresis characteristic to serve as a comparator for carrying out said binary conversion demodulation process on the waveform of said transmitted signal generated by said electrostatic capacitive coupler at said signal receiving electrode.

3. A communication apparatus operating as said signal transmitting apparatus in said communication system according to claim 1, said communication apparatus comprising:
a memory used for storing said transmitted data;
a signal transmitting amplifier configured to amplify said baseband signal representing said transmitted data to a proper level; and
said signal transmitting electrode to which said amplified baseband signal is supplied,
wherein, in conjunction with said signal receiving electrode employed in said signal receiving apparatus positioned at a location closely coupling to said communication apparatus so as to expose said signal receiving electrode to said signal transmitting electrode, said signal transmitting electrode forms an electrostatic capacitive coupler and allows said transmitted signal to propagate through a small capacitance, which is created between said signal transmitting electrode and said signal receiving electrode.

4. A communication apparatus operating as said signal receiving apparatus, which is employed in said communication system according to claim 1 as an apparatus comprising:
said signal receiving electrode; and
said signal demodulation means, wherein
when said signal transmitting electrode employed in said signal transmitting apparatus is positioned at a location closely coupling to said signal receiving electrode in order to expose said signal transmitting electrode to said signal receiving electrode,
in conjunction with said signal transmitting electrode, said signal receiving electrode forms an electrostatic capacitive coupler, and
said received signal passing through a small capacitance, which is created between said signal transmitting electrode and said signal receiving electrode, and arriving at said signal receiving electrode as said received signal is subjected to a binary conversion demodulation process carried out by said signal demodulation means in order to reproduce said baseband signal.

5. The communication apparatus according to claim 4, wherein said signal demodulation means has a comparator provided with a hysteresis characteristic to serve as a comparator for carrying out said binary conversion demodulation process on the waveform of said transmitted signal generated by said electrostatic capacitive coupler at said signal receiving electrode.
